(19) United States
(12) Patent Application Publication
(10) Pub. No.: US 2025/0333256 A1
(43) Pub. Date: Oct. 30, 2025

(54) VEHICLE RESTRAINT WITH ENHANCED SLIDING SURFACE

(71) Applicant: ASSA ABLOY Entrance Systems AB, Landskrona (SE)

(72) Inventor: L. Blake Whitley, Arlington, TX (US)

(21) Appl. No.: 18/647,801

(22) Filed: Apr. 26, 2024

(51) Int. Cl. B65G 69/00

(52) U.S. Cl. CPC B65G 69/003

(57) ABSTRACT

A vehicle restraint for restraining a vehicle or trailer at a dock includes a ramp assembly disposed to slidably engage a rear impact guard (RIG) bar of the vehicle or trailer, a vertical slide frame operably coupled to the ramp assembly to lower the vertical slide frame from a resting height to a height of the RIG bar against a bias toward the resting height responsive to the RIG bar slidably engaging the ramp assembly during motion of the RIG bar toward the dock in a first direction, and a hook barrier operably coupled to the vertical slide frame to receive the RIG bar and rotate to retain the RIG bar responsive to the motion of the RIG bar in the first direction. The ramp assembly includes a top plate defining a top surface that faces the RIG bar and is disposed at an angle relative to the first direction. The ramp assembly includes one or more instances of a contact strip disposed at a portion of the top plate extending away from the top surface to prevent contact between the RIG bar and the top surface.

### TECHNICAL FIELD

Example embodiments generally relate to vehicle restraints and, in particular, relate to vehicle restraints for restraining transport trucks, trailers, and/or other vehicles at loading docks that include an enhanced sliding surface.

### BACKGROUND

Vehicle restraints are well known in the material handling industry and are typically used to prevent a trailer or other transport vehicle from moving away from a loading dock during the loading and/or unloading process. Absent a restraint, the vehicle may tend to move away from the loading dock for a number of reasons, such as the slope of the driveway, the kinetic energy imparted to the vehicle by a fork truck or personnel during the loading or unloading process, etc. If the vehicle is allowed to move away from the dock face, a gap may form between the vehicle and the dock face or between the vehicle and the lip of an associated dock leveler. If this occurs, a fork truck operator could inadvertently drive into the gap, or other personnel could inadvertently step into the gap, potentially damaging equipment or injuring personnel.

Unlike wheel chocks, conventional vehicle restraints typically engage the Rear Impact Guard (“RIG”) bar of the vehicle. As is well known, RIG bars (which can also be referred to as “ICC” bars) are horizontal members that extend across the rear of the vehicle below the bed. In the U.S., regulations require that the vertical distance between the bottom edge of the RIG bar and the ground not exceed 22 inches at any point across the full width of the member, and that the rearmost surface of the RIG bar be within 12 inches of the rear extremity of the vehicle.

There are several different types of vehicle restraints. Some of these types of vehicle restrains may employ a restraining member (e.g., a hook) operably coupled to a vertically-moving carriage having rollers that ride on a track mounted to the face of the loading dock to lock the RIG bar in place, and others may move a bar or other blocking member into place to prevent movement of the RIG bar. While it can be appreciated that many different ways of accomplishing the same goal can be employed, some examples of prior art restraints in this area are disclosed in U.S. Pat. Nos. 4,472,099, 4,443,150, 4,282,621, 4,264,259, 4,208,161, 4,373,847, 4,379,354, 4,560,315, and RE 32,968.

For examples that employ a locking hook, to engage with the restraint, the vehicle backs into the loading dock until the RIG bar contacts an angled lead-in surface of the restraint carriage, causing the carriage to move downwardly on the track as the RIG bar continues moving back. Eventually the RIG bar moves onto a horizontal surface of the restraint carriage that extends rearward from the angled lead-in surface, enabling the locking hook to rotate upwardly to engage the RIG bar and secure the vehicle adjacent the loading dock.

The angled lead-in surface mentioned above is therefore, by design, positioned to take an initial blow or strike from the RIG bar, when the RIG bar makes first contact with the vehicle restraint. The initial blow is then followed by sliding contact while the RIG bar moves up the angled lead-in surface, and toward the horizontal surface on which engagement with the locking hook occurs. U.S. Pat. No. 6,322,310 discloses examples of this type or angled lead-in surface. The initial blow, and the sliding contact thereafter, may cause dents, scratches or other discontinuities in the angled lead-in surface. These discontinuities may further lead to the formation of rust, pitting, corrosion and other unsightly or higher friction inducing surface phenomena that may reduce the performance or lifespan of the vehicle restraint. Example embodiments may provide a solution to addressing these problems.

### BRIEF SUMMARY OF SOME EXAMPLES

In an example embodiment, a vehicle restraint for restraining a vehicle or trailer at a dock is provided. The vehicle restraint may include a ramp assembly disposed to slidably engage a rear impact guard (RIG) bar of the vehicle or trailer, a vertical slide frame operably coupled to the ramp assembly to lower the vertical slide frame from a resting height to a height of the RIG bar against a bias toward the resting height responsive to the RIG bar slidably engaging the ramp assembly during motion of the RIG bar toward the dock in a first direction, and a hook barrier operably coupled to the vertical slide frame to receive the RIG bar and rotate to retain the RIG bar responsive to the motion of the RIG bar in the first direction. The ramp assembly includes a top plate defining a top surface that faces the RIG bar and is disposed at an angle relative to the first direction. The ramp assembly includes one or more instances of a contact strip disposed at a portion of the top plate extending away from the top surface to prevent contact between the RIG bar and the top surface.

In another example embodiment, a vehicle restraint system for restraining a vehicle or trailer at a dock may be provided. The vehicle restraint system may include a set of vertically mounted rails fixed to the dock and a vehicle restraint operably coupled to the rails. The vehicle restraint may include a ramp assembly disposed to slidably engage a RIG bar of the vehicle or trailer, a vertical slide frame operably coupled to the ramp assembly to lower the vertical slide frame from a resting height to a height of the RIG bar against a bias toward the resting height responsive to the RIG bar slidably engaging the ramp assembly during motion of the RIG bar toward the dock in a first direction, and a hook barrier operably coupled to the vertical slide frame to receive the RIG bar and rotate to retain the RIG bar responsive to the motion of the RIG bar in the first direction. The ramp assembly includes a top plate defining a top surface that faces the RIG bar and is disposed at an angle relative to the first direction. The ramp assembly includes one or more instances of a contact strip disposed at a portion of the top plate extending away from the top surface to prevent contact between the RIG bar and the top surface.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 shows a side view of a vehicle restraint with the hook rotated to a receiving position according to an example embodiment;

FIG. 2 illustrates a side view of the vehicle restraint with a hook thereof in a locking or retaining position according to an example embodiment;

FIG. 3 illustrates a perspective view of the vehicle restraint with the hook in the locking or retaining position according to an example embodiment;

FIG. 4 is an exploded view of a nose ramp in accordance with an example embodiment;

FIG. 5 shows a perspective view of the nose ramp of FIG. 4 in a fully assembled state according to an example embodiment;

FIG. 6 illustrates the nose ramp of FIG. 5 with branding provided on a top plate thereof in accordance with an example embodiment;

FIG. 7 illustrates a perspective view of an alternative structure for a nose ramp according to an example embodiment;

FIG. 8 illustrates a perspective view of an alternative structure for a nose ramp according to an example embodiment;

FIG. 9A illustrates a cross section view of a prior art nose ramp;

FIG. 9B illustrates a cross section view of the nose ramp of FIG. 8 in accordance with an example embodiment;

FIG. 10 illustrates a perspective view of a vehicle restraint having the nose ramp of FIG. 7 in accordance with an example embodiment; and

FIG. 11 illustrates a side view of the vehicle restraint having the nose ramp of FIG. 8 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Certain details are set forth in the following description and in the Figures to provide a thorough understanding of various embodiments of the present technology. In other instances, well-known structures, materials, operations and/or systems often associated with vehicle restraint systems, loading docks, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below. In the Figures, identical reference numbers identify identical, or at least generally similar, elements.

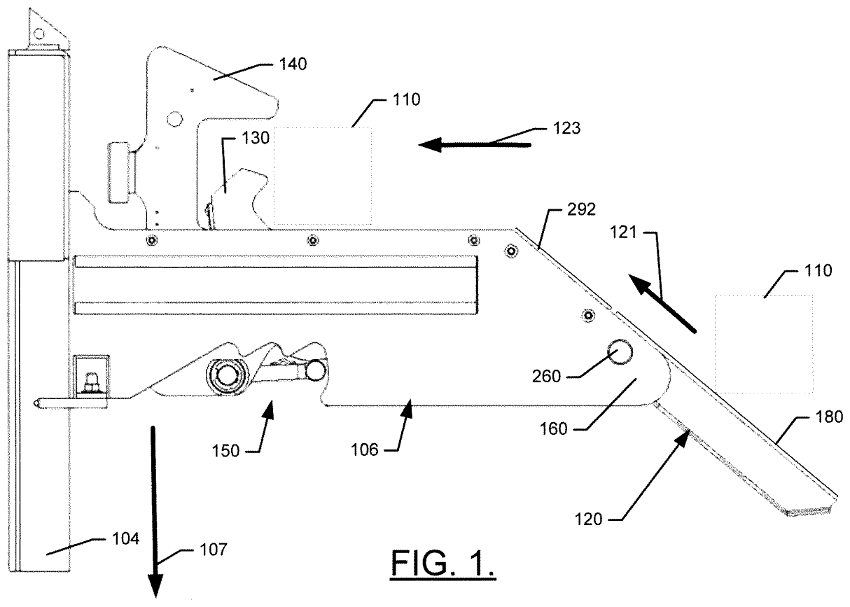

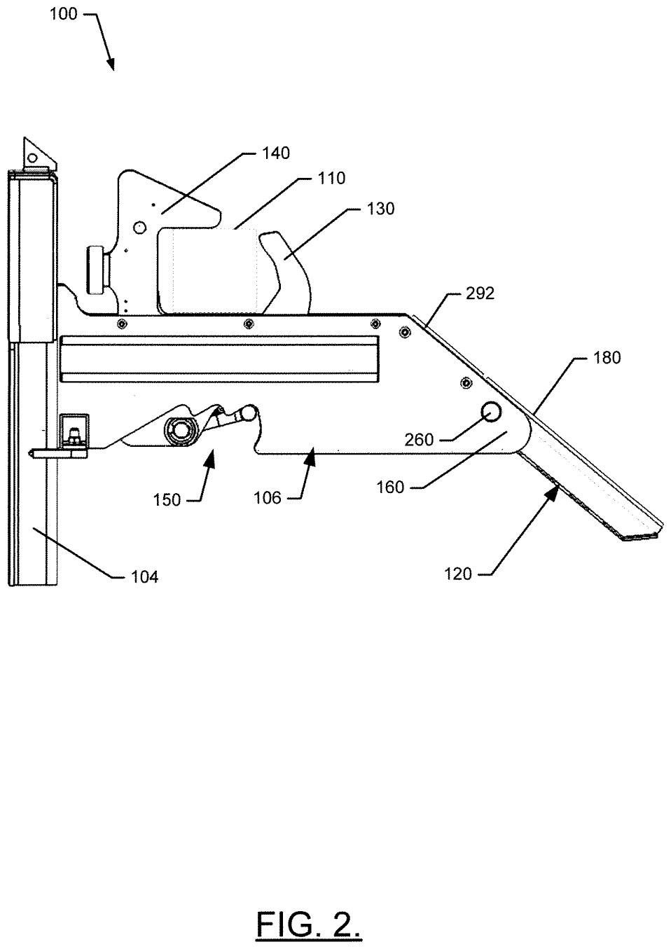

FIG. 1 shows a vehicle restraint 100 prior to locking and FIG. 2 shows the vehicle restraint 100 in a locked state. Referring to FIG. 1, the vehicle restraint 100 may include two main assemblies of components that are interoperable and structured to cooperate in the restraining of a vehicle without using a motor. In an example embodiment, these two main assemblies may include a vertical slide assembly and a horizontal slide assembly that combine to form a carriage assembly. The carriage assembly includes portions that move vertically (via the vertical slide assembly) and horizontally (via the horizontal slide assembly) to support interaction with the RIG bar. In this regard, the vertical slide assembly may provide for movement vertically to accommodate respective different RIG bar heights on various different vehicles (or their trailers). The horizontal slide assembly may provide for movement horizontally to transition (without a motor) the vehicle restraint 100 between an engaged (or locked) state with respect to a RIG bar 110 and a disengaged (or unlocked) state with respect to the RIG bar 110 position.

The vehicle restraint 100 may include or otherwise be operably coupled to a dock mounting structure 102, which may include rails 104 that extend vertically relative to the ground, and are spaced apart from each other extending parallel to each other. The dock mounting structure 102 may include metal brackets or the like for operable coupling to a dock via fasteners (e.g., bolts, screws, etc.). The rails 104 may form a portion of the vertical slide assembly along with a vertical slide frame 106 providing a main body or base structure to which other components of the vehicle restraint 100 attach. The dock mounting structure 102, the rails 104 and in some cases other auxiliary equipment (e.g., electronic status indicators) may combine to define a vertical restraint system of an example embodiment.

The vertical slide frame 106 may be disposed in a rest or home position by a vertical biasing assembly, and the RIG bar 110 may engage a ramp assembly 120 to displace the vertical slide frame 106 out of the rest position and downward in direction of arrow 107 as the RIG bar 110 slidably engages the ramp assembly 120 and moves along the ramp assembly 120 in the direction of arrow 121 until a locking height is reached. When the locking height is reached, the RIG bar 110 may no longer engage the ramp assembly 120, and slides horizontally along a top surface of the vertical slide frame 106 back into contact with a hook barrier 130. The vertical slide frame 106 may remain substantially at the locking height for the remainder of the locking sequence of the vehicle restraint 100.

In an example embodiment, the vertical biasing assembly of the vertical slide assembly may include vertically arranged rollers and one or more biasing members (e.g., springs) that bias the vertical slide frame 106 toward a base (or highest) height at the rest position. As the RIG bar 110 rides along the ramp assembly 120, the spring (or springs) may be compressed (or extended) as the rollers move vertically downward to increase biasing forces on the vertical slide frame 106 back toward the rest position. When the RIG bar 110 has advanced beyond the ramp assembly 120, the vertical slide frame 106 will achieve the locking height, and retain the locking height with continued motion of the RIG bar 110 in the rearward direction of arrow 123 moving the RIG bar 110 along the top of the vertical slide frame 106 until the hook barrier 130 is contacted (as shown in FIG. 1), and the further movement of the RIG bar 110 then causes the hook barrier 130 to rotate to the locked position shown in FIG. 2.

The horizontal slide assembly may provide for movement horizontally to transition (without a motor) the vehicle restraint 100 between an engaged (or locked) state with respect to the RIG bar 110 and a disengaged (or unlocked) state with respect to the RIG bar 110. To accomplish this, the horizontal slide assembly may include a horizontal slide frame 140 providing a main body or base structure to which other components of the horizontal slide assembly attach, and to provide a structure for operable coupling to the vertical slide assembly.

The horizontal slide frame 140 may travel rearward with the RIG bar 110 (i.e., in the direction of arrow 123) and reposition a locking assembly 150 responsive to displacement (or carrying) of the horizontal slide frame 140 out of its normal rest position as the RIG bar 110 slidably engages the horizontal slide frame 140 to transition the horizontal slide assembly (and thereby also the vehicle restraint 100) to an engaged state. In an example embodiment, the horizontal slide frame 140 may include therein, a biasing assembly that may include horizontally arranged rollers and one or more biasing members (e.g., springs) that bias the horizontal slide frame 140 toward the stored position. As the RIG bar 110 repositions the horizontal slide frame 140 and carries it rearward (e.g., toward the dock to which the vehicle restraint 100 is mounted), the hook barrier 130 may rotate to the position shown in FIG. 2, and the locking assembly 150 may also engage to maintain the horizontal slide frame 140 in its locked position. Other detailed aspects of the structure and operation of the vehicle restraint 100 are outside the scope of this disclosure, and may also vary in different embodiments.

The ramp assembly 120 may typically take the initial impact from the RIG bar 110, as mentioned above. The ramp assembly 120 may be retained by carrying plates 160 that form lateral sides of the vertical slide frame 106. The ramp assembly 120 may be referred to variously as a nose ramp or a ramp extension leg in some cases, and may be formed of steel that is typically a same or similar thickness to that which is used to form the carrying plates 160. In this regard, for example, the carrying plates 160 may each be about 5/16 inch in thickness, and may be disposed about 2.5 inches apart in parallel with each other. Although not required, the steel used to form the carrying plates 160 may be ASTM A572 Grade 50 with a minimum yield strength of about 50,000 lb per square inch (psi) and a Brinell-Hardness of about 135 HB.

Even if the ramp assembly 120 is also made of the same robust steel as the carrying plates 160, as noted above, the numerous instances of impact with the RIG bar 110 may cause corrosion or damage to a top surface (i.e., the surface that faces toward and engages with an incoming instance of the RIG bar 110) of the ramp assembly 120. The top surface of the ramp assembly 120 is typically exposed to contact over its entire area. Thus, the top surface may typically be synonymous with or even referred to as a contact surface for a typical vehicle restraint. However, in order to spare the top surface from impact, damage, corrosion, etc., example embodiments may define a smaller and more discrete structure for contact with the RIG bar 110 that reduces the contact area so that the contact area is essentially much smaller than the area of the top surface, and is focused on the smaller and more discrete structure. Example embodiments may provide this more discrete contact area in the form of one or more instances of a contact strip 180 (or friction strip) formed at or proximate to the top surface of the ramp assembly 120.

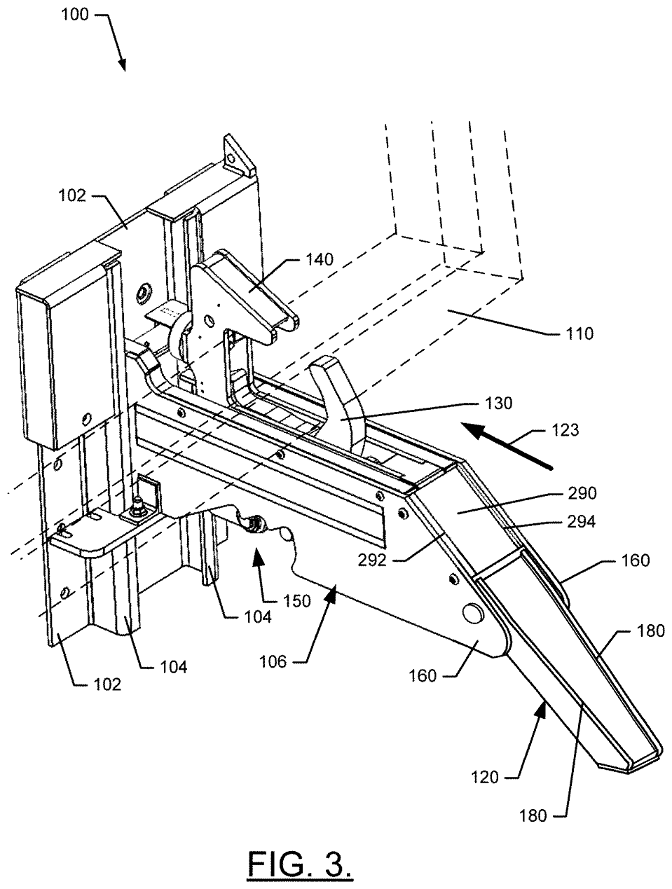

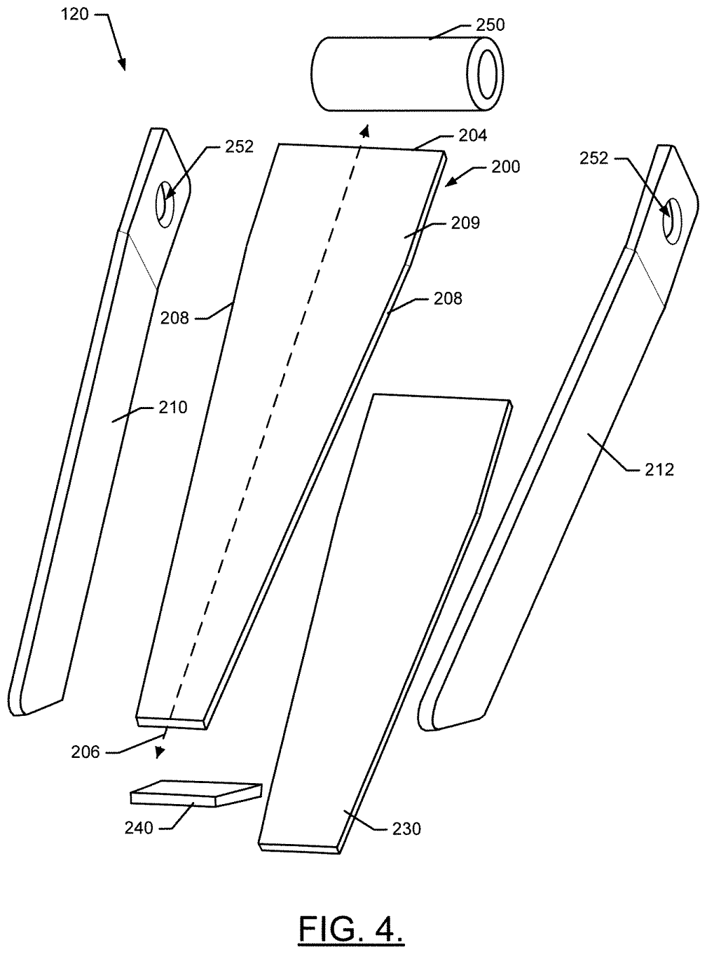

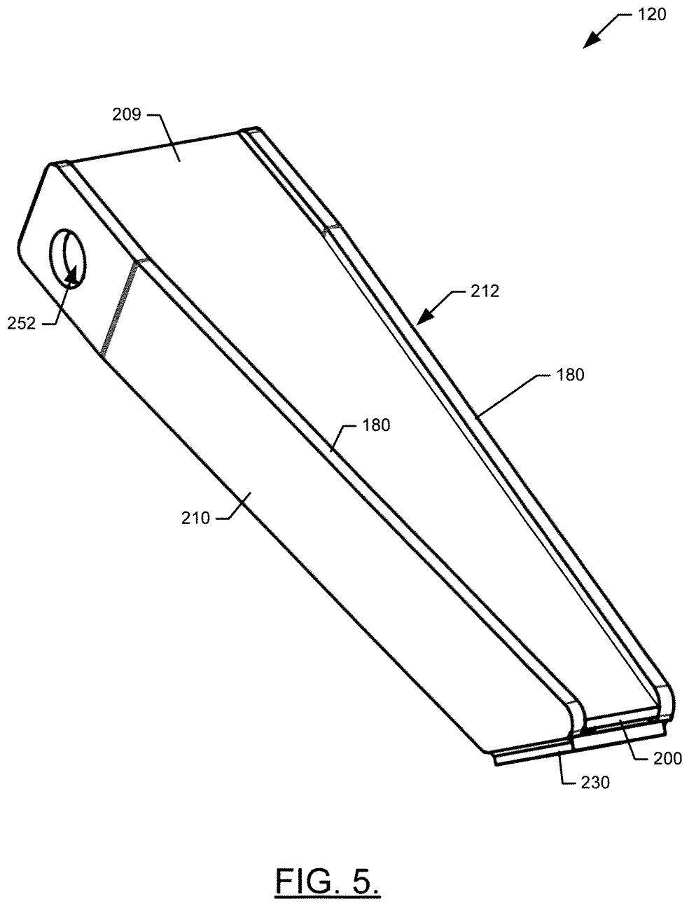

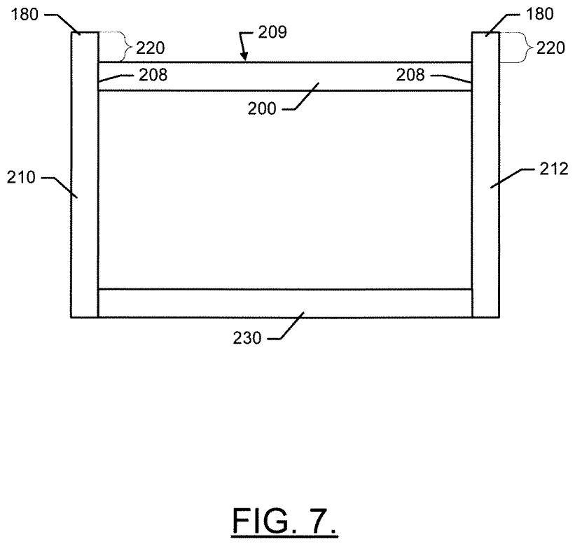

The contact strip 180 (or strips) may be formed in any of various different ways, and FIGS. 1-3 illustrate one example structure for the contact strip 180. However, to more fully appreciate details of the contact strip 180 of this example embodiment, FIGS. 4-6 provide more exploded and perspective views in isolation, and FIG. 7 shows a cross section view, which will now be referred to by way of example and not limitation.

Referring to FIGS. 4-7, the ramp assembly 120 may include a top plate 200 and two side plates (e.g., first side plate 210 and second side plate 212). The top plate 200 may have a distal end 202 and a proximal end 204, and a longitudinal centerline 206 that extends therebetween. Lateral edges 208 of the top plate 200 may extend along opposite sides thereof to mirror each other about the longitudinal centerline 206. The length of the top plate 200 may vary, but lengths between about 12-20 inches may be employed, and between about 16-17 inches may be common. In some embodiments, the top plate 200 may be a rectangular sheet or plate of steel having a consistent width (e.g., about 2-6 inches) and thickness (e.g., 5/16 inch thick) all along its length. However, in some cases, the width of the top plate 200 may taper as the distal end 202 is approached, as shown in FIG. 4. Regardless of whether the width of the top plate 200 is consistent or tapering, the first and second side plates 210 and 212 may be disposed on opposite lateral sides of the top plate 200, and may be attached to the top plate 200 to mirror each other about opposing sides of a longitudinal centerline 206 of the top plate 200.

The top plate 200 may be a substantially flat or plate-like sheet of steel or other rigid material. Similarly, the first and second side plates 210 and 212 may also be substantially flat or plate-like sheets of steel or other rigid material. However, if the top plate 200 tapers, then a bend may be placed in each of the first and second side plates 210 and 212 to allow the first and second side plates 210 and 212 to match the taper of the top plate 200 while engaged with the lateral sides of the top plate 200. In an example embodiment, each of the first and second side plates 210 and 212 may be substantially rectangular in shape, and may have a length that is about as long as the top plate 200. However, in the depicted example, a distal end of each of the first and second side plates 210 and 212 may be shortened at an edge of the first and second side plates that is opposite the edge proximate the top plate 200. This tapering also creates a ramp shape (albeit inverted) at the distal end of the ramp assembly 120.

The first and second side plates 210 and 212 may be attached to the lateral edges 208 of the top plate 200 proximate to a lateral edge of each of the first and second side plates 210 and 212. The first and second side plates 210 and 212 may be attached to the top plate 200 by welding in some embodiments, but may be positioned prior to welding such that a portion of the first and second side plates 210 extends beyond a top surface 209 of the top plate 200 by an extension distance 220. The portion of each of the first and second side plates 210 extends beyond a top surface 209 of the top plate 200 defines the contact strip 180 (shown best in FIG. 7, which represents a cross section view along a plane passing perpendicular to the longitudinal centerline 206) to have a depth of the extension distance 220. The extension distance 220 defines a minority portion of the first and second side plates 210 and 212 that extends from a top lateral edge of each of the first and second side plates 210 and 212 to the top surface 209, and is therefore above the top plate 200. The majority portion of the first and second side plates 210 and 212 extends in the opposite direction and is therefore below the top plate 200.

Although not required, for further reinforcement of the ramp assembly 120, the ramp assembly 120 may be a weldment that includes additional structural members including a bottom plate 230 and a foot plate 240 that closes off the otherwise open end of the four sided structure formed by the combination of the top plate 200, the first and second side plates 210 and 212, and the bottom plate 230 proximate to the distal end 202 of the top plate 200. Meanwhile, portions of the first and second side plates 210 and 212 that are proximate the proximal end 204 of the top plate 200 may be reinforced by being attached (e.g., welded) to a reinforcement tube 250 that may be a hollow cylinder extending between engagement orifices 252 formed in each of the first and second side plates 210 and 212 to face each other. An attachment pin 260 (see FIG. 1) may be passed through the engagement orifices 252 and the hollow center of the reinforcement tube 250 to connect the ramp assembly 120 to the carrying plates 160 of the vertical slide frame 106. By providing connection of the ramp assembly 120 to the carrying plates 160 via the attachment pin 260, some amount of flexing of the ramp assembly 120 responsive to contact with the RIG bar 110 may be provided.

By forming the lateral edges of the first and second side plates 210 and 212 to extend proud of, or prominent with respect to, the top surface 209, the top surface 209 may be protected from impact and contact with the RIG bar 110. As such, the entire extension distance 220 defines a wear surface that can be impacted or contacted by the RIG bar 110, and that can be worn away or even corrode to some degree, but still preserve the top surface 209 from marring or damage. The wear surface defined by the contact strips 180 has substantially less area and therefore less contact area than the contact area that would exist under typical designs where the top surface 209 is exposed to contact with the RIG bar 110. This provides less friction and less force interaction between the RIG bar 110 and the vehicle restraint 100.

Notably, the extension distance 220 of the contact strip 180 may be chosen to have a height (or depth) that is sufficient to balance durability in response to impact or contact with the RIG bar 110 and minimization of contact area and friction. Since the width of the contact strip 180 is likely determined by the thickness of the first and second side plates 210 and 212 (which may be between ¼ to ½ inch in some cases), the height of the contact strip 180 (i.e., the extension distance 220) may be selected before welding or attachment, and therefore provides greater design freedom for the designer.

Whereas a higher or larger extension distance 220 may provide for a longer life in consideration of material removal that may occur due to frictional contact over a period of time, this consideration has to be balanced against the fact that a larger extension distance 220 also creates additional exposure to a possibility of being bent or damaged due to an indirect strike from the RIG bar 110 or other high load event that may ultimately end up reducing the useful life of the ramp assembly 120. In an example embodiment, defining the extension distance 220 in a range of between ⅛ to ⅜ inches (or even between 3/16 to ¼ inches) may be expected to define a service life of at least 10 years. In some cases, 3/16 inches provides a good balance of protection for the top surface 209 and long service life without excessive damage to the contact strips 180.

In an example embodiment, the extension distance 220 may be chosen to be less than or equal to a thickness of the first and second side plates 210 and 212. Moreover, in some cases, ratios such as ¼, ⅓ or ½ the thickness of the first and second side plates 210 and 212 may also be chosen with relatively good results. Moreover, in some cases, the contact strip 180 may be coated with, or formed from, a different material than that which is used to form the base structure of the ramp assembly 120. For example, nylon, various other polymers, or even certain metallic coatings may be applied to a surface of the contact strip 180, or may form the contact strip 180, in other example embodiments.

In some embodiments, a transition plate 290 may be disposed between the carrying plates 160 between the proximal end 204 of the top plate 200 and the hook barrier 130. The transition plate 290 may be aligned with the ramp assembly 120 in relation to the angle it forms with the horizontal portion (i.e., top portion) of the vertical slide frame 106. Thus, the RIG bar 110 may slide continuously and relatively seamlessly from the ramp assembly 120 to the transition plate 290 when moving in the direction of arrow 121. The transition plate 290 may therefore be further provided with a third contact strip 292 aligned with a first one of the contact strips 180, and a fourth contact strip 294 aligned with a second one of the contact strips 180. The third and fourth contact strips 292 and 294 may prevent contact between the RIG bar 110 and a top surface of the transition plate 290.

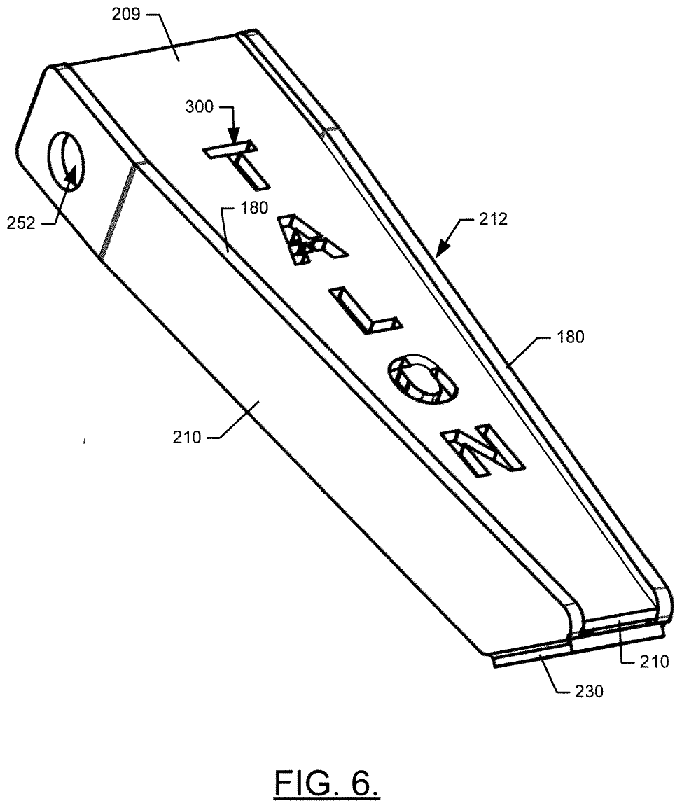

Notably, for an example such as the one shown in FIGS. 1-6, in which a width of the top plate 200 tapers toward the distal end 202, a combined surface area of the contact strips 180 may be less than 20% of a surface area of the top surface 209. Moreover, in some embodiments, the combined surface area of the contact strips 180 may be less than 10% or even less than 5% of the surface area of the top surface 209. Thus, reductions in the amount of friction may be significant, and the surfaces exposed to frictional engagement may be drastically reduced. Moreover, the top surface 209 may be preserved from rust, damage and corrosion, which may in turn make the top surface 209 suitable or even desirable for the presentation of branding, logos, graphics, words or other visual media 300. In this regard, FIG. 6 shows an example in which the visual media 300 provided on the top surface 209 may be made by either removing material from the top surface 209 to form letters, logos, graphics, etc., or affixing painted or other graphical images or the like to the top surface 209. Notably, when material is removed, the material may form an embossed image or character (or set of the same), or the material may be removed to create corresponding openings that pass entirely through the top plate 200.

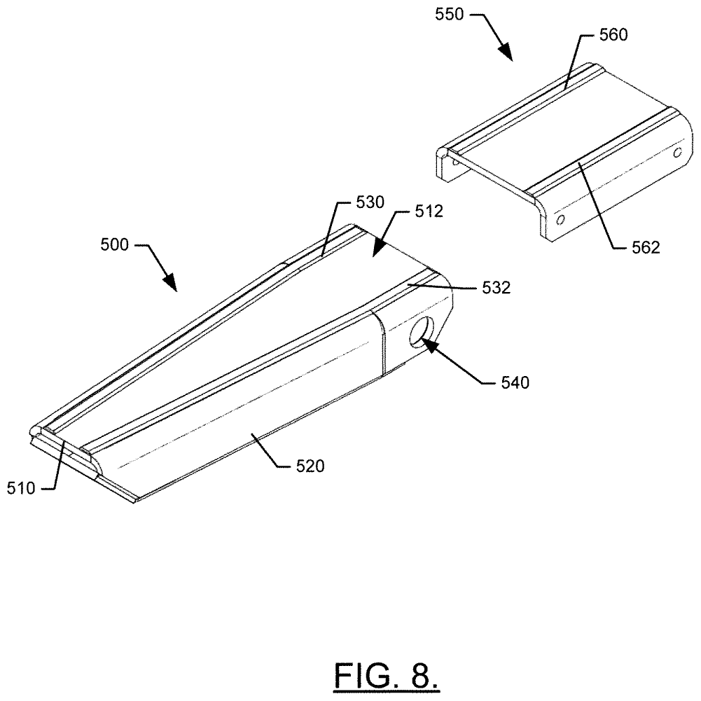

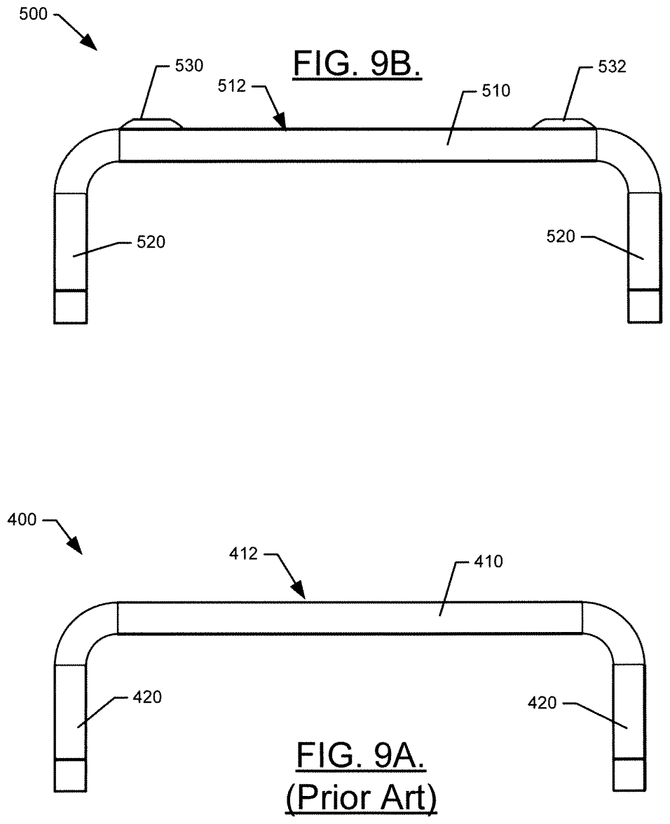

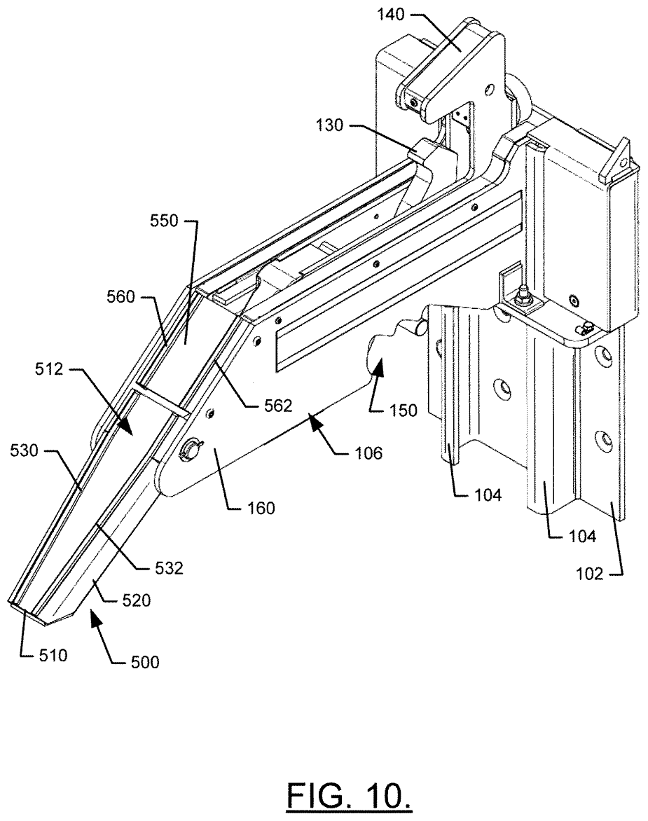

The example described above uses a series of plates that are welded together to form the contact strip 180 where the contact strip 180 is actually a portion of one of the weldment components. However, there may be other ways to form contact strips. In this regard, for example, FIGS. 8A-11 illustrate an alternative example in which instead of a weldment of relatively flat pieces that are welded together to form the ramp assembly 120, a different strategy is employed.

Turning to FIGS. 8A-11, FIG. 8A illustrates a cross section view of a prior art nose ramp 400 that is formed from a single unitary piece of metal (e.g., steel). The nose ramp 400 has a top member 410 that includes a top surface 412, which is the contact surface for a RIG bar. Extending substantially perpendicularly away from the top surface 412, sidewalls 420 are provided at the opposing lateral edges of the top member 410. The top member 410 and the sidewalls 420 are formed from one unitary piece of metal, so there is no joint between them, and the sidewalls 420 transition into the top member 410 at a bend formed therebetween. For the example of FIG. 8A, the top surface 412 can be expected to undergo significant wear and weathering over time leading to surface degradation (e.g., scratching and pitting) that may render the top surface 412 unsightly, and in any case unusable for branding, logos, graphics, etc.

To cure this deficiency, example embodiments may modify an otherwise similarly structured nose ramp 500 including a top member 510 with a top surface 512 and sidewalls 520 that are all situated as described above for the prior art example of FIG. 8A. The modification may include the provision of a first contact strip 530 and a second contact strip 532, each of which is added to the top surface 512 as a wear surface near (but spaced apart from) edges of the top member 510. The first and second contact strips 530 and 532 of this example may be welded onto the top surface 512 in some cases. However, in other cases, the top surface 512 may be machined to have material removed to form the first and second contact strips 530 and 532 to extend prominently away from (or proud of) the top surface 512 that remains after machining. In either case, the first and second contact strips 530 and 532 may extend substantially a full length of the top surface 512. Although not required, in this example, the first and second contact strips 530 and 532 are provided proximate to the bend formed between the sidewalls 520 and the top member 510. However, the first and second contact strips 530 and 532 could be located farther away from the bend, and therefore also farther away from lateral edges of the top surface 512 in some cases. Moreover, as few as one contact strip may be provided in some cases, or as many as desired could alternatively be provided so long as the general goal of reducing the area over which frictional engagement is experienced is accomplished.

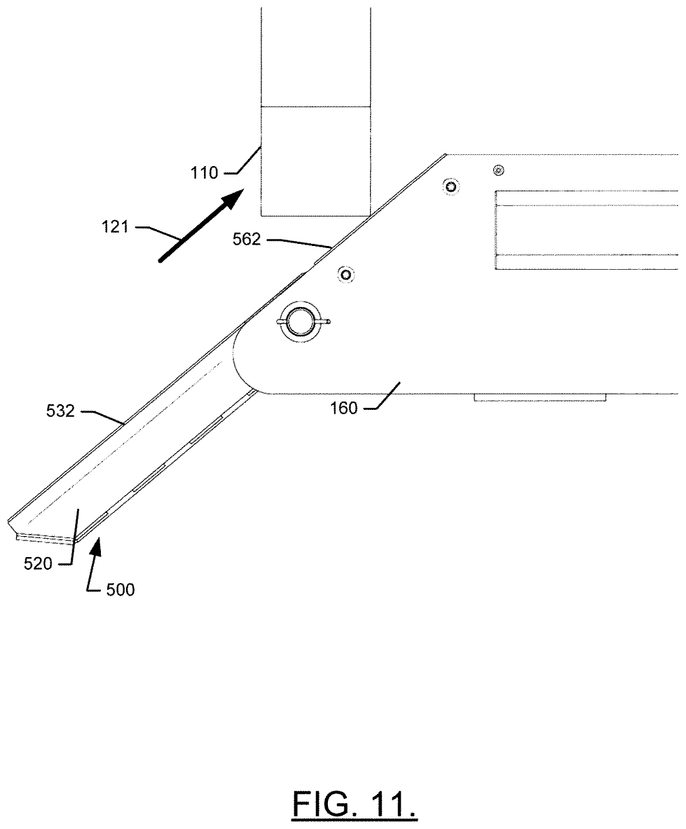

The nose ramp 500 is tapered like the example of FIGS. 1-6 above. However, tapering could alternatively be eliminated, and the nose ramp 500 (and its top surface 512) could be rectangular in shape in some cases. The nose ramp 500 may include engagement orifices 540 that may couple the nose ramp 500 to the carrying plates 160 of the vehicle restraint 100 in the same manner discussed above. Additionally, the example embodiment of FIGS. 7-11 may also include a transition plate 550 that may be disposed between the carrying plates 160 and may be situated also between a proximal end of the top member 510 and the hook barrier 130. The transition plate 550 of this example is also aligned with the nose ramp 500 in relation to the angle it forms with the horizontal portion (i.e., top portion) of the carrying plates 160 of the vertical slide frame 106. The transition plate 550 may also be provided with a third contact strip 560 aligned with the first contact strip 530, and a fourth contact strip 562 aligned with the second contact strip 532. The third and fourth contact strips 560 and 562 may prevent contact between the RIG bar 110 and a top surface of the transition plate 550 after the RIG bar 110 slides along the nose ramp 500 to reach the transition plate 550 moving in the direction of arrow 121 as shown in FIG. 11.

Accordingly, based on the descriptions above, it can be appreciated that a vehicle restraint for restraining a vehicle or trailer at a dock may include a ramp assembly disposed to slidably engage a RIG bar of the vehicle or trailer, a vertical slide frame operably coupled to the ramp assembly to lower the vertical slide frame from a resting height to a height of the RIG bar against a bias toward the resting height responsive to the RIG bar slidably engaging the ramp assembly during motion of the RIG bar toward the dock in a first direction, and a hook barrier operably coupled to the vertical slide frame to receive the RIG bar and rotate to retain the RIG bar responsive to the motion of the RIG bar in the first direction. The ramp assembly includes a top plate defining a top surface that faces the RIG bar and is disposed at an angle relative to the first direction. The ramp assembly includes one or more instances of a contact strip disposed at a portion of the top plate extending away from the top surface to prevent contact between the RIG bar and the top surface.

The vehicle restraint and/or a system including the same, or components thereof described above may be augmented or modified by altering individual features mentioned above or adding optional features. The augmentations or modifications may be performed in any combination and in any order. For example, in some cases, the one or more instances of the contact strip may include a first contact strip disposed to extend along a first lateral edge of the top plate, and a second contact strip disposed to extend along a second lateral edge of the top plate. In an example embodiment, the ramp assembly may further include a first side plate and a second side plate. The first and second side plates may be attached to the top plate at opposing lateral sides of the top plate such that a majority portion of the first and second side plates extend substantially perpendicularly away from the top plate in a direction opposite the top surface, and a minority portion of the first and second side plates extend substantially perpendicularly away from the top plate on a same side as the top surface to define an extension distance. The extension distance of the first and second side plates may define the first and second contact strips, respectively. In some cases, the first and second side plates may be attached to the top plate via welding. In an example embodiment, the one or more instances of the contact strip may include a first contact strip disposed to extend from a proximal end of the top plate to a distal end of the top plate and a second contact strip disposed to extend from the proximal end to the distal end mirroring the first contact strip about a longitudinal centerline of the top plate. In some cases, the first contact strip may be spaced apart from a first lateral edge of the top plate, and the second contact strip may be spaced apart from a second lateral edge of the top plate. In an example embodiment, the first and second contact strips may be welded to the top surface of the top plate. In some cases, the top plate may have a larger width at a proximal end of the top plate than at a distal end of the top plate, and the one or more instances of the contact strip may include a first contact strip and a second contact strip that are spaced apart from each other by a greater distance at the proximal end than at the distal end. In an example embodiment, the vertical slide frame may include carrying plates disposed on opposite sides of the ramp assembly to retain the ramp assembly at the angle relative to the first direction via an attachment pin passing through the carrying plates and engagement orifices of the ramp assembly. In some cases, a transition plate may be disposed between the carrying plates between the proximal end and the hook barrier, and the transition plate may include a third contact strip aligned with the first contact strip, and a fourth contact strip aligned with the second contact strip, where the third and fourth contact strips prevent contact between the RIG bar and a top surface of the transition plate. In an example embodiment, the contact strip may include a width greater than or equal to a height of the contact strip above the top surface. In some cases, a height of the contact strip is between about ⅛ to ⅜ inches, or even between about 3/16 to ¼ inches. In an example embodiment, the top plate may include visual media disposed at the top surface. In some cases, the contact strip may include a nylon, composite material or metallic coating.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A vehicle restraint for restraining a vehicle or trailer at a dock, the vehicle restraint comprising:
a ramp assembly disposed to slidably engage a rear impact guard (RIG) bar of the vehicle or trailer;
a vertical slide frame operably coupled to the ramp assembly to lower the vertical slide frame from a resting height to a height of the RIG bar against a bias toward the resting height responsive to the RIG bar slidably engaging the ramp assembly during motion of the RIG bar toward the dock in a first direction; and
a hook barrier operably coupled to the vertical slide frame to receive the RIG bar and rotate to retain the RIG bar responsive to the motion of the RIG bar in the first direction,
wherein the ramp assembly comprises a top plate defining a top surface that faces the RIG bar and is disposed at an angle relative to the first direction, and
wherein the ramp assembly comprises one or more instances of a contact strip disposed at a portion of the top plate extending away from the top surface to prevent contact between the RIG bar and the top surface.

2. The vehicle restraint of claim 1, wherein the one or more instances of the contact strip comprise a first contact strip disposed to extend along a first lateral edge of the top plate, and a second contact strip disposed to extend along a second lateral edge of the top plate.

3. The vehicle restraint of claim 2, wherein the ramp assembly further comprises a first side plate and a second side plate, the first and second side plates being attached to the top plate at opposing lateral sides of the top plate such that a majority portion of the first and second side plates extend substantially perpendicularly away from the top plate in a direction opposite the top surface, and a minority portion of the first and second side plates extend substantially perpendicularly away from the top plate on a same side as the top surface to define an extension distance, and
wherein the extension distance of the first and second side plates defines the first and second contact strips, respectively.

4. The vehicle restraint of claim 3, wherein the first and second side plates are attached to the top plate via welding.

5. The vehicle restraint of claim 1, wherein the one or more instances of the contact strip comprise a first contact strip disposed to extend from a proximal end of the top plate to a distal end of the top plate and a second contact strip disposed to extend from the proximal end to the distal end mirroring the first contact strip about a longitudinal centerline of the top plate.

6. The vehicle restraint of claim 5, wherein the first contact strip is spaced apart from a first lateral edge of the top plate, and the second contact strip is spaced apart from a second lateral edge of the top plate.

7. The vehicle restraint of claim 6, wherein the first and second contact strips are welded to the top surface of the top plate.

8. The vehicle restraint of claim 1, wherein the top plate has a larger width at a proximal end of the top plate than at a distal end of the top plate, and
wherein the one or more instances of the contact strip comprise a first contact strip and a second contact strip that are spaced apart from each other by a greater distance at the proximal end than at the distal end.

9. The vehicle restraint of claim 8, wherein the vertical slide frame comprises carrying plates disposed on opposite sides of the ramp assembly to retain the ramp assembly at the angle relative to the first direction via an attachment pin passing through the carrying plates and engagement orifices of the ramp assembly.

10. The vehicle restraint of claim 8, wherein a transition plate is disposed between the carrying plates between the proximal end and the hook barrier, and
wherein the transition plate comprises a third contact strip aligned with the first contact strip, and a fourth contact strip aligned with the second contact strip, the third and fourth contact strips preventing contact between the RIG bar and a top surface of the transition plate.

11. The vehicle restraint of claim 1, wherein the contact strip comprises a width greater than or equal to a height of the contact strip above the top surface.

12. The vehicle restraint of claim 11, wherein a height of the contact strip is between about ⅛ to ⅜ inches.

13. The vehicle restraint of claim 11, wherein a height of the contact strip is between about 3/16 to ¼ inches.

14. The vehicle restraint of claim 1, wherein the top plate comprises visual media disposed at the top surface.

15. The vehicle restraint of claim 1, wherein the contact strip comprises a nylon, composite material or metallic coating.

16. A vehicle restraint system for restraining a vehicle or trailer at a dock, the vehicle restraint system comprising:
a set of vertically mounted rails fixed to the dock; and
a vehicle restraint operably coupled to the rails, the vehicle restraint comprising:
a ramp assembly disposed to slidably engage a rear impact guard (RIG) bar of the vehicle or trailer;
a vertical slide frame operably coupled to the ramp assembly to lower the vertical slide frame from a resting height to a height of the RIG bar against a bias toward the resting height responsive to the RIG bar slidably engaging the ramp assembly during motion of the RIG bar toward the dock in a first direction; and
a hook barrier operably coupled to the vertical slide frame to receive the RIG bar and rotate to retain the RIG bar responsive to the motion of the RIG bar in the first direction,
wherein the ramp assembly comprises a top plate defining a top surface that faces the RIG bar and is disposed at an angle relative to the first direction, and
wherein the ramp assembly comprises one or more instances of a contact strip disposed at a portion of the top plate extending away from the top surface to prevent contact between the RIG bar and the top surface.

17. The vehicle restraint system of claim 16, wherein the one or more instances of the contact strip comprise a first contact strip disposed to extend along a first lateral edge of the top plate, and a second contact strip disposed to extend along a second lateral edge of the top plate, and
wherein the ramp assembly further comprises a first side plate and a second side plate, the first and second side plates being welded to the top plate at opposing lateral sides of the top plate such that a majority portion of the first and second side plates extend substantially perpendicularly away from the top plate in a direction opposite the top surface, and a minority portion of the first and second side plates extend substantially perpendicularly away from the top plate on a same side as the top surface to define an extension distance, and
wherein the extension distance of the first and second side plates defines the first and second contact strips, respectively.

18. The vehicle restraint system of claim 16, wherein the one or more instances of the contact strip comprise a first contact strip disposed to extend from a proximal end of the top plate to a distal end of the top plate and a second contact strip disposed to extend from the proximal end to the distal end mirroring the first contact strip about a longitudinal centerline of the top plate,
wherein the first contact strip is spaced apart from a first lateral edge of the top plate, and the second contact strip is spaced apart from a second lateral edge of the top plate, and
wherein the first and second contact strips are welded to the top surface of the top plate.

19. The vehicle restraint system of claim 16, wherein the top plate has a larger width at a proximal end of the top plate than at a distal end of the top plate, and
wherein the one or more instances of the contact strip comprise a first contact strip and a second contact strip that are spaced apart from each other by a greater distance at the proximal end than at the distal end.

20. The vehicle restraint system of claim 16, wherein the contact strip comprises a width greater than or equal to a height of the contact strip above the top surface, and
wherein a height of the contact strip is between about ⅛ to ⅜ inches.
